(19) United States
(12) Patent Application Publication
(10) Pub. No.: US 2025/0312724 A1
(43) Pub. Date: Oct. 9, 2025

(54) System and Method for Reducing Onion-Cutting Discomfort Using a Smartphone Application to Generate Radio Frequencies

(71) Applicant: Chris Koltun, Regina (CA)

(72) Inventor: Chris Koltun, Regina (CA)

(21) Appl. No.: 18/625,374

(22) Filed: Apr. 3, 2024

(51) Int. Cl. B01D 53/00; H04M 1/21

(52) U.S. Cl. CPC B01D 53/007; H04M 1/21; B01D 2257/306; B01D 2257/708; B01D 2259/80

(57) ABSTRACT

A smartphone application and method for generating radio frequencies is provided. The application utilizes smartphone hardware to generate radio frequency energy that mitigates the effect of lachrymator particles released during onion cutting. By emitting non-ionizing radiation, the application reduces the discomfort and tearing experienced from the lachrymator particles. The intensity and frequency of non-ionizing radiation is controllable through the smartphone interface.

### BACKGROUND OF THE INVENTION

The present invention relates to a system and method for reducing onion cutting discomfort using a smartphone application designed to enhance user comfort and safety in kitchen environments. More specifically, the invention pertains to an application that utilizes radio frequency technology via a smartphone to mitigate the effects of lachrymator particles released during the cutting of onions, which are a common source of discomfort.

In culinary practices, the preparation of food often involves the cutting of onions, a process known to cause eye irritation and tearing due to the release of lachrymator particles. The process of cutting onions involves the mechanical disruption of the onion's cellular structure leading to a series of biochemical reactions. When the onion's cells are damaged through cutting, slicing, or crushing, enzymes present in the cytosol, notably alliinase, are released and come into contact with the amino acid sulfoxides. One of the primary compounds produced is syn-propanethial-S-oxide, identified as the chief lachrymatory agent or lachrymator. This volatile compound rapidly diffuses into the air and, upon contact with the eyes, it reacts with the moisture to form sulfuric acid. The sulfuric acid stimulates the eyes' lachrymal glands, causing irritation and the production of tears as a protective response to flush the irritant from the eye surface.

Various solutions have been proposed to address this issue, ranging from physical barriers such as goggles to more traditional methods like chilling onions prior to cutting. However, these solutions come with their own set of limitations. Goggles can be cumbersome and uncomfortable. Moreover, they may impair the wearer's vision of the onion while cutting, which can be dangerous.

Some existing solutions that aim to reduce kitchen-related discomfort often involve the use of specialized equipment, which can be expensive, occupy valuable kitchen space, and require maintenance. For example, onions can be cut with a food processor such that at least some of the cut onion remains in an enclosed container. However, a portion of the cut onion being fed into the food processor remains open to the atmosphere and the volatility of the blade can eject lachrymator particles into the air. These solutions, while effective to a degree, do not offer the convenience and accessibility desired by many users. Moreover, they fail to provide a seamless integration into the cooking process, often necessitating additional preparation, equipment, and cleanup time.

The current invention introduces a system and method for reducing onion cutting discomfort using a smartphone, which is omnipresent in todays' age. The present invention does not require the acquisition of any additional, specialized equipment nor does it necessitate any preparatory actions that might alter the food's natural qualities. By emitting radio frequencies that effectively reduce the concentration of lachrymator particles in the vicinity of the cutting area, this application offers a user-friendly solution. Smartphones are already integrated into daily life, thereby eliminating the barriers to adoption posed by extra gadgets or significant changes in cooking behavior.

In view of these developments, there exists a need for an application that runs on a smartphone that can efficiently mitigate the discomfort caused by lachrymator particles during onion cutting without requiring physical barriers, altering the food's preparation process, or necessitating additional, specialized equipment.

In light of the devices disclosed in the known art, it is submitted that the present invention substantially diverges in design elements and methods from the known art and consequently it is clear that there is a need in the art for an improvement in radio waves generating application that run on smartphones. In this regard the instant invention substantially fulfills these needs.

### SUMMARY OF THE INVENTION

In view of the foregoing disadvantages inherent in the known types of smartphone applications and methods for generating radio frequencies now present in the known art, the present invention provides a new application that runs on a smartphone that can efficiently mitigate the discomfort caused by lachrymator particles during onion cutting.

It is an objective of the present invention to provide a smartphone application configured to generate radio frequencies. The smartphone application generates radio frequency using hardware of the smartphone to reduce the presence of lachrymator particles in the air, thereby minimizing eye irritation and tear production without necessitating physical barriers or altering the food's preparation process.

It is an objective of the present invention to provide a smartphone application that is accessible and easy to use. By integrating with smartphones, which are readily availability, the application eliminates the need for additional, specialized equipment, offering a practical solution that fits seamlessly into the user's cooking routine.

It is an objective of the present invention to provide a smartphone application for generating radio frequencies that offers adjustable settings for the emission intensity and frequency. This customization allows users to track and set the specific intensity and frequency through an interface on the smartphone.

It is an objective of the present invention to provide a method for reducing the discomfort associated with cutting onions utilizing a smartphone application designed to emit radio frequencies tailored to mitigate the effects of lachrymator particles.

It is therefore an object of the present invention to provide a new and improved system and method that utilize a smartphone and smartphone application for reducing the discomfort associated with cutting onions that has all of the advantages of the known art and none of the disadvantages.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a diagram of one embodiment of the system for reducing the discomfort associated with cutting onions.

FIG. 2 shows a block diagram of one embodiment of a smartphone of the system for reducing the discomfort associated with cutting onions.

### DETAILED DESCRIPTION OF THE INVENTION

Reference is made herein to the attached drawings. Like reference numerals are used throughout the drawings to depict like or similar elements of the system. For the purpose of presenting a brief and clear description of the present invention, the embodiment discussed will be used in a kitchen when onions are being cut producing lachrymator particle proximate to an onion cutting area. The figures are intended for representative purposes only and should not be considered to be limiting in any respect. Furthermore, the described features, structures, or characteristics may be combined in any suitable manner in one or more embodiments. In the following description, numerous specific details are provided to give a thorough understanding of embodiments.

Reference will now be made in detail to the exemplary embodiment(s) of the invention. References to “one embodiment,” “at least one embodiment,” “an embodiment,” “one example,” “an example,” “for example,” and so on indicate that the embodiment(s) or example(s) may include a feature, structure, characteristic, property, element, or limitation but that not every embodiment or example necessarily includes that feature, structure, characteristic, property, element, or limitation. Further, repeated use of the phrase “in an embodiment,” “first embodiment,” “second embodiment,” or “third embodiment” does not necessarily refer to the same embodiment.

As used herein “smartphone” includes a wide range of communication devices capable of running applications and connecting to the Internet. These devices are equipped with an operating system capable of supporting software applications, and they typically feature a touchscreen interface for user interaction, along with various sensors and hardware components that enable a multitude of functions. Examples include but are not limited to, phones, tablets, wearable smart devices, and the like.

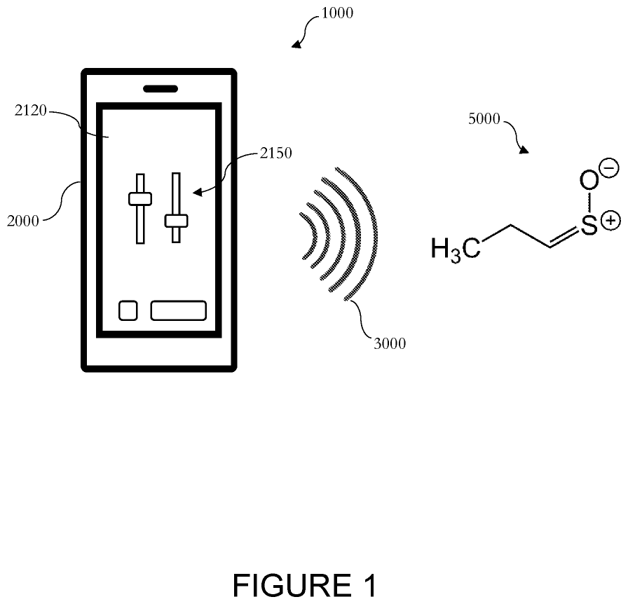

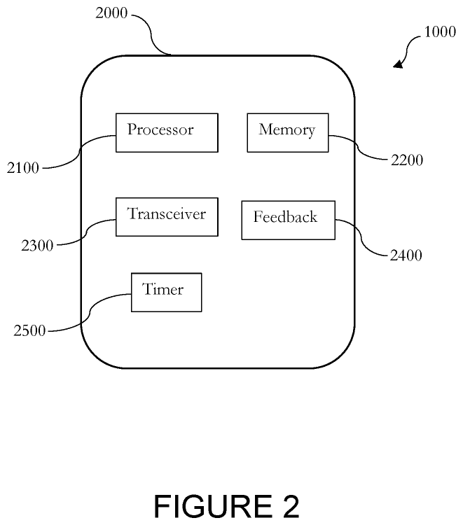

Referring to FIGS. 1 and 2, there is shown a diagram of one embodiment of the system for reducing the discomfort associated with cutting onions and a block diagram of one embodiment of a smartphone of the system for reducing the discomfort associated with cutting onions, respectively. The system 1000 comprises a smartphone 2000 having a processor 2100, non-transitory computer-readable memory 2200 containing logic, and a transceiver 2300. The transceiver 2200 is adapted to generate radio frequencies. A smartphone application is adapted to run on the smartphone 2000 and generate radio frequencies for reducing eye irritation caused by syn-propanethial-S-oxide 5000 found in lachrymator particles released during onion cutting.

In the shown embodiment, the smartphone 2000 provides a hardware platform equipped with the transceiver 2300 for emitting a broad range of non-ionizing radiation 3000 at target frequencies. The smartphone 2000 includes memory 2200 adapted to store the application and run when not connected to the internet, Wi-Fi, or any other communications network. The software application is executed by the processor, accessing the memory to control the transceiver 2300 according to user settings and environmental conditions. In one embodiment, the target frequencies are between 3 kHz to 300 GHz, wherein the target frequencies are configured to interact with the lachrymator particle proximate to an onion cutting area.

The application features an interface 2120 to receive inputs from the users and display the controls. In one embodiment, the users adjust the intensity and frequency of the RF emissions by interacting with a slider 2150 on the display of the smartphone 2000. Settings can be customized based on the onion type, cutting environment, and user sensitivity, optimizing the effectiveness of the invention. Additionally, the application includes a feedback system, guiding users on optimal smartphone placement relative to the cutting area to ensure maximum coverage and protection.

Referring specifically to FIG. 1, the smartphone is further configured to adjust the emission intensity based on user input or environmental sensors detecting the concentration of lachrymator particles. In the shown embodiment, the application is configured to provide user feedback on optimal smartphone placement relative to the onion cutting area to maximize the effectiveness of reducing lachrymator particle concentration. The feedback mechanism (2400 in FIG. 2) employs a combination of haptic (vibrational), visual (on-screen instructions or indicators), and auditory signals to guide the user in positioning the smartphone optimally. By leveraging these various forms of feedback, the application ensures that users can easily and accurately locate the best spot for their device, thereby enhancing the protective effect against eye irritation.

In one embodiment, the application includes a timer (2500 in FIG. 2) function to automatically deactivate the radio frequency emission after a set period. The timer automatically deactivates the radio frequency emission after a predetermined period. This conserves the smartphone's battery life and ensuring the device is not left emitting RF unnecessarily.

Referring specifically to FIG. 2, there is shown a block diagram of one embodiment of the system. In the shown embodiment, the smartphone 2000 includes runs the application to cause the generation of the radio frequencies. In some embodiments, multiple frequencies and phases are generated simultaneously. In this way, this allows for the generation of radio waves that interact with the lachrymator particle and communicate with communications networks, such as the internet, Wi-Fi, or cellular communications networks. In one embodiment, the processor is further configured to execute instructions allowing manual adjustment of the radio frequency for different types of onions or environmental conditions.

In one exemplary method, the user launches the application on their smartphone begins by ensuring they have a smartphone that includes a processor, a transceiver configured to generate radio frequencies, and a non-transitory computer-readable memory that houses the application logic. Upon activating the specialized smartphone application, the user is presented with an interface designed to control the emission of non-ionizing radiation. This application, configured for mitigating the discomfort associated with cutting onions, allows the user to select the frequency of radio frequency emission. Such customization enables adaptation to various environmental conditions and personal preferences, enhancing the user's control over the system's operation. As the user engages with the application, it employs the smartphone's transceiver to emit non-ionizing radiation at the selected frequencies.

To aid in the effective deployment of this technology, the application provides intuitive feedback—be it haptic, visual, or auditory—guiding the user to position the smartphone optimally. In some embodiments, the smartphone will be positioned on a countertop next to the cutting board or area in close proximity, such as 0.5-2 meters, to the cutting of the onions. This ensures that the emitted frequencies are directed precisely where they are most needed to neutralize the lachrymator particles efficiently. While the lachrymator particles are produced by the onions, the frequencies interact with the lachrymator particles to reduce the effect on the user. In some embodiments, the frequencies slow the reactions that form the syn-propanethial-S-oxide. After the onion preparation is completed, a timer is activated to disable the radio frequency emission, or the user deactivates the transceiver.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A system for reducing the discomfort associated with cutting onions, comprising:
a smartphone comprising:
a processor;
a transceiver adapted to generate radio frequencies;
a non-transitory computer-readable memory containing logic;
wherein the processor configured to access the memory and execute the logic, causing the smartphone to:
activate a smartphone application configured to generate non-ionizing radiation at target frequencies via the transceiver;
wherein the target frequencies are between 3 kHz to 300 GHz, wherein the target frequencies are configured to interact with a lachrymator particle proximate to an onion cutting area.

2. The system of claim 1, wherein the smartphone is further configured to:
adjust the emission intensity based on user input or environmental sensors detecting the concentration of lachrymator particles.

3. The system of claim 2, wherein the smartphone is further configured to:
provide user feedback on optimal smartphone placement relative to the onion cutting area to maximize the effectiveness of reducing lachrymator particle concentration.

4. The system of claim 1, wherein the smartphone application includes a user interface allowing the user to select emission intensity levels manually.

5. The system of claim 1, wherein the application provides haptic, visual, or auditory feedback to guide the user in placing the smartphone optimally.

6. The system of claim 1, wherein the application includes a timer function to automatically deactivate the radio frequency emission after a set period.

7. The system of claim 1, wherein the processor is further configured to execute instructions allowing manual adjustment of the radio frequency for different types of onions or environmental conditions.

8. A method for reducing the discomfort associated with cutting onions, the method comprising:
providing a smartphone comprising:
a processor;
a transceiver adapted to generate radio frequencies;
a non-transitory computer-readable memory containing logic;
activating a smartphone application on the smartphone configured to generate radio frequencies;
utilizing the transceiver to emit non-ionizing radiation at target frequencies adapted to reduce the concentration of lachrymator particles in the air proximate to an onion cutting area;
wherein the emission mitigates the eye irritation and tear production induced by the cutting of onions.

9. The method of claim 8, wherein the smartphone application includes a user interface for selecting the frequency of the radio frequency emission.

10. The method of claim 8, wherein the smartphone further comprises a timer within the application that automatically deactivates the radio frequency emission after a predetermined period to conserve energy.

11. The method of claim 8, further comprising:
providing a haptic, visual, or auditory feedback to guide the user in placing the smartphone.
